(19) United States
(12) Patent Application Publication
(10) Pub. No.: US 2009/0077274 A1
(43) Pub. Date: Mar. 19, 2009

(54) Multi-Priority Communication in a Differential Serial Communication Link

(75) Inventors: Gordon F. Caruk, Brampton (CA); Anthony Asaro, Scarborough (CA)

Correspondence Address: ADVANCED MICRO DEVICES, INC.;C/O VEDDER PRICE P.C., 222 N.LASALLE STREET, CHICAGO, IL, 60601, US

(73) Assignee: Advanced Micro Devices, Markham (CA)

(21) Appl. No.: 11/857,984

(22) Filed: Sep. 19, 2007

(51) Int. Cl. G06F 3/00

(52) U.S. Cl. 710/29

(57) ABSTRACT

A circuit includes a high priority circuit and a non-high priority circuit. The high priority circuit is operative to communicate high priority information to a single path of a differential serial communication link. The non-high priority circuit communicates non-high priority information to the single path. The high priority information is communicated prior to the non-high priority information. In one example, the circuit includes a flow control distributor operatively coupled to the high priority circuit and the non-high priority circuit. The flow control distributor distributes a total number of flow control credits into high priority credits and non-high priority credits. The flow control distributor controls communication of the high priority information based on the high priority credits. The flow control distributor controls communication of the non-high priority information based on the non-high priority credits.

### FIELD

The present disclosure generally relates to differential serial communication circuits, and more particularly, to a method and apparatus for communicating multi-priority information using differential communication circuits.

### BACKGROUND

Increasing processing speeds of input/output (I/O) devices such as graphics processors, hard disks, network cards, and other high speed I/O devices have created a need for an increased bandwidth between a chipset and the I/O device. One way to increase bandwidth between the chipset and the I/O device is to use a differential serial communication link such as PCI Express™. PCI Express™ is a flexible, hybrid serial-parallel interface format that uses multiple differential communication links often referred to as virtual channels. Each link includes transmit lanes to transmit information and receive lanes to receive information.

Each differential serial communication link requires additional hardware. Therefore, using multiple differential serial communication links requires more hardware than using a single differential serial communication link. The additional hardware increases the size of the chipset, which is undesirable in many portable device applications. Furthermore, the additional hardware may also increase power consumption for integrated circuits, which is also undesirable in many portable devices.

In addition, some applications do not allow multiple differential serial communication links when each link cannot alias all requests into a snoop required path. Therefore, only a single differential serial communication link is available. However, using only a single differential serial communication link may cause high priority information to become queued behind lower priority information, which is undesirable.

It is therefore desirable, among other things, to provide a method and apparatus to improve throughput of high priority information in a differential communication link with minimal hardware to support the differential communication link.

### BRIEF DESCRIPTION OF THE DRAWINGS

The invention will be more readily understood in view of the following description when accompanied by the below figures, wherein like reference numerals represent like elements:

FIG. 1 is a functional block diagram of one example of a device that includes a multi-priority communication system;

FIG. 2 is a flowchart depicting exemplary steps that may be taken by the multi-priority communication system;

FIG. 3 is a functional block diagram of one example of the multi-priority communication system;

FIG. 4 is a functional block diagram of one example of a flow control distributor of the multi-priority communication system;

FIG. 5 is a flowchart depicting exemplary steps that may be taken by the flow control distributor; and

FIG. 6 is a functional block diagram of an exemplary implementation of a high priority control circuit and a non-high priority control circuit of the multi-priority communication system.

### DETAILED DESCRIPTION

In one example, a circuit includes a high priority circuit and a non-high priority circuit. The high priority circuit communicates high priority information to a single path of a differential serial communication link. The non-high priority circuit communicates non-high priority information to the single path. When available, the high priority information is communicated prior to the non-high priority information. In one example, the circuit includes a flow control distributor operatively coupled to the high priority circuit and the non-high priority circuit. The flow control distributor distributes a total number of flow control credits into high priority credits and non-high priority credits. The flow control distributor controls communication of the high priority information based on the high priority credits. The flow control distributor controls communication of the non-high priority information based on the non-high priority credits. A method is also employed that provides the described functionality.

The circuit and method provide, among other advantages, deterministic throughput of high priority information in a single differential serial communication link. By using a single differential serial communication link, hardware required to support the link is minimized. Minimizing the hardware required to support the link can result in reduced power consumption and can help to decrease the overall size of the circuit and/or a device using the circuit. In addition, the circuit and method provides multi-priority communication in applications that do not allow multiple differential serial communication links. Other advantages will be recognized by those of ordinary skill in the art.

In one example, the circuit includes a packet generator that generates a packet based on the high priority information or the non-high priority information. The packet includes a header parameter that indicates whether the packet includes high priority information or non-high priority information. In one example, a traffic class parameter in the header is set to a first value when the packet includes the high priority information. The traffic class parameter is set to a second value when the packet includes the non-high priority information.

In one example, the flow control distributor includes a distributor, a high priority tracking circuit, and a non-high priority tracking circuit. The distributor distributes the total number of flow control credits into high priority credits and non-high priority credits. The high priority tracking circuit adds at least one credit to the high priority credits based a on total number of flow control credits (e.g., flow control credit updates). The high priority tracking circuit subtracts at least one credit from the high priority credits when the high priority information is communicated. The non-high priority tracking circuit adds at least one credit to the non-high priority credits based on the total number of flow control credits (e.g., flow control credits updates). The non-high priority tracking circuit subtracts at least one credit from the non-high priority credits when the non-high priority information is communicated.

In one example, a circuit includes a packet parser, a high priority circuit, and a non-high priority circuit. The packet parser receives a packet from a single path of a differential serial communication link. The packet parser classifies the packet into either high priority information or non-high priority information. The high priority circuit communicates the high priority information to a non-blocking high priority interface. The non-high priority circuit communicates the non-high priority information to a non-high priority interface. A method is also employed that provides the described functionality.

In one example, a multi-priority communication system includes an upstream integrated circuit and a downstream integrated circuit. The upstream integrated circuit includes a packet parser, an upstream high priority circuit, and an upstream non-high priority circuit. The packet parser receives a packet from a single upstream path of a differential serial communication link. The packet parser classifies the packet into high priority information or non-high priority information. The upstream high priority circuit communicates the high priority information to a non-blocking high priority interface. The upstream non-high priority circuit communicates the non-high priority information to a non-high priority interface. The downstream integrated includes a downstream high priority circuit, a downstream non-high priority circuit, and a flow control distributor. The downstream high priority circuit communicates the high priority information to the single upstream path. The downstream non-high priority circuit communicates non-high priority information to the single upstream path. When available, the high priority information is communicated prior to the non-high priority information. The flow control distributor is operatively coupled to the downstream high priority circuit and the downstream non-high priority circuit. The flow control distributor distributes a total number of flow control credits into high priority credits and non-high priority credits. The flow control distributor controls communication of the high priority information based on the high priority credits. The flow control distributor controls communication of the non-high priority information based on the non-high priority credits.

In one example, a device includes at least one processor, memory, a multi-priority communication system, and a display. The multi-priority communication system is operatively coupled to the at least one processor and memory. The multi-priority communication system includes an upstream integrated circuit and a downstream integrated circuit. The upstream integrated circuit includes a packet parser, an upstream high priority circuit, and an upstream non-high priority circuit. The packet parser receives a packet from a single upstream path of a differential serial communication link. The packet parser classifies the packet into high priority information or non-high priority information. The upstream high priority circuit communicates the high priority information to a non-blocking high priority interface operatively coupled to memory. The upstream non-high priority circuit communicates the non-high priority information to a non-high priority interface. The downstream integrated includes a downstream high priority circuit, a downstream non-high priority circuit, and a flow control distributor. The downstream high priority circuit communicates the high priority information to the single upstream path. The downstream non-high priority circuit communicates non-high priority information to the single upstream path. The high priority information is communicated prior to the non-high priority information. The flow control distributor is operatively coupled to the downstream high priority circuit and the downstream non-high priority circuit. The flow control distributor distributes a total number of flow control credits into high priority credits and non-high priority credits. The flow control distributor controls communication of the high priority information based on the high priority credits. The flow control distributor controls communication of the non-high priority information based on the non-high priority credits. The display is operatively coupled to the multi-priority communication system. The display generates display information based on the high priority information.

As used herein, the terms “module,” “circuit,” and/or “stage” can include an electronic circuit, one or more processors (e.g., shared, dedicated, or group of processors such as but not limited to microprocessors, DSPs, or central processing units), and memory that execute one or more software or firmware programs, combinational logic circuits, an ASIC, and/or other suitable components that provide the described functionality.

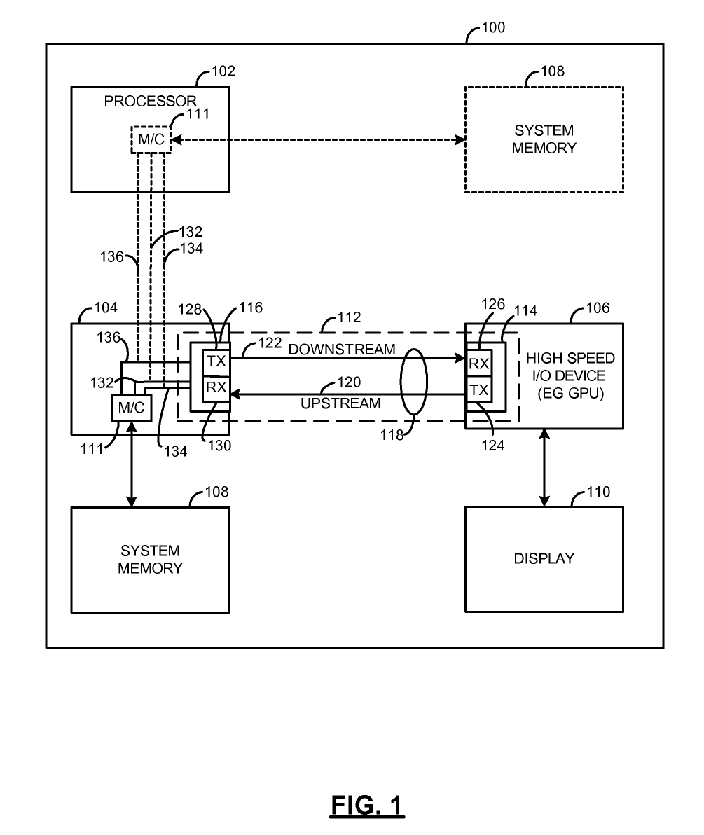

Referring now to FIG. 1, a functional block diagram of a device 100 such as a wireless phone, a mobile and/or stationary computer, a printer, a LAN interface (wireless and/or wired), a media player, a video decoder and/or encoder, and/or any other suitable digital device is depicted. The device 100 includes at least one processor 102, a chipset 104 such a bridge circuit to memory and/or an I/O device, a high speed I/O device 106 such as a graphics processor (or core) and associated display 110, a hard disk, a network card, or other suitable high speed I/O device, and system memory 108.

The processor 102 is operatively coupled to the chipset 104 and processes requests from the chipset 104. In some embodiments, the chipset 104 includes a memory controller 111 that is operatively coupled to the system memory 108. The system memory 108 stores information communicated from the chipset 104. In other embodiments, the processor 102 includes the memory controller 111 that is operatively coupled to the system memory 108, which stores information communicated from the processor 102. The chipset 104 and the high speed I/O device 106 communicate via a multi-priority communication system 112.

The multi-priority communication system 112 includes a downstream circuit 114 and an upstream circuit 116. In some embodiments, the downstream circuit 114 and upstream circuit 116 may each be implemented as a respective integrated circuit. The downstream circuit 114 and the upstream circuit 116 are operative to communicate via a differential serial communication link 118 such a PCI Express™ or any other suitable differential serial communication link. The differential serial communication link 118 includes an upstream path 120 and a downstream path 122. The downstream circuit 114 includes a downstream transmitter 124 and a downstream receiver 126. The downstream transmitter 124 communicates information in the form of packets to the upstream path 120. The downstream receiver 126 receives information in the form of packets from the downstream path 122. The upstream circuit 116 includes an upstream transmitter 128 and an upstream receiver 130. The upstream transmitter 128 communicates information in the form of packets to the downstream path 122. The upstream receiver 130 receives information in the form of packets from the upstream path 120.

To prevent the transmitter 124, 128 from sending too much information to the receiver 126, 130, the multi-priority communication system 112 uses a flow control mechanism. In the flow control mechanism, the receiver 126, 130 provides the transmitter 124, 128 with a certain number of credits that correspond to an amount of buffer space that the receiver 126, 130 has available to store incoming information. When the credits are used up, the transmitter 124, 128 stops sending information until the receiver 126, 130 frees up more credits. The multi-priority communication system 112 allocates the credits for a single differential serial communication link into high priority flow control credits and non-high priority flow control credits to control priority of information communicated over the differential serial communication link 118.

The non-high priority requests are communicated to a non-high priority interface 132 of the memory controller 111. The high priority requests are communicated to a non-blocking high priority interface 134 of the memory controller 111. The non-blocking high priority interface 134 ensures that the high priority request is communicated to system memory 108 without the information being blocked or queued for any appreciable amount of time. In this manner, the high-priority requests are communicated to system memory 108 prior to the non-high priority requests. In response to the high priority requests, the memory controller 111 retrieves information based on the high priority request from system memory 108 and communicates the information to the upstream circuit 116 via a non-blocking completion path 136. The non-blocking completion path 136 ensures that the information retrieved from system memory 108 is communicated to the upstream circuit 116 without being blocked or queued for any appreciable amount of time.

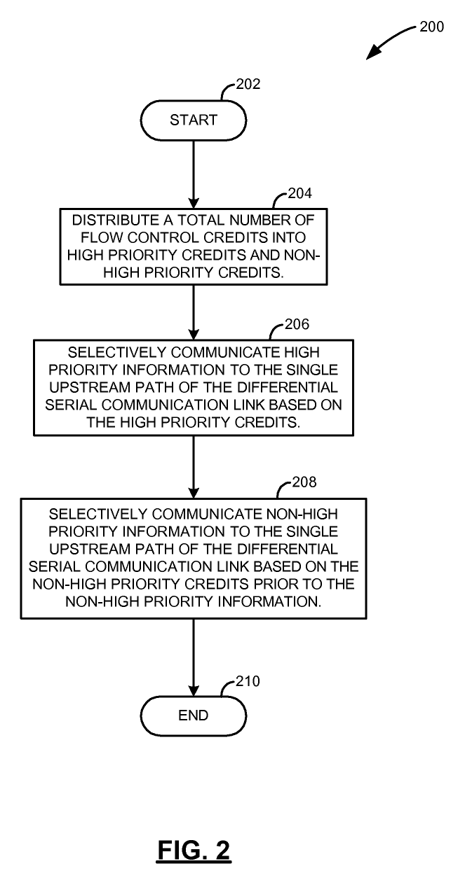

Referring now to FIG. 2, exemplary steps that may be taken by the downstream circuit 114 of the multi-priority communication system 112 or any other suitable structure is generally identified at 200. The process starts in step 202 when the upstream receiver 130 gives the downstream transmitter 124 a total number of flow control credits. In step 204, the downstream circuit 114 distributes (e.g., divides) the total number of flow control credits into both high priority credits and non-high priority credits. For example, if there are a total of 60 flow control credits, they may be distributed into 20 high priority credits and 40 non-high priority credits.

In step 206, the downstream circuit 114 selectively communicates high priority information to the upstream path 120 of the differential serial communication link 118 based on the high priority credits. More specifically, the downstream circuit 114 communicates high priority information to the upstream path when there are enough high priority credits to communicate the information. If there are not enough high priority credits, the downstream circuit 114 waits to communicate the high priority information until the upstream receiver 130 gives the downstream transmitter 124 enough credits to communicate the information.

In step 208, the downstream circuit 114 selectively communicates non-high priority information to the upstream path 120 of the differential serial communication link 118 based on the non-high priority credits such that the high priority information is communicated prior to the non-high priority information. More specifically, the downstream circuit 114 communicates non-high priority information to the upstream path when there are enough non-high priority credits to communicate the information. If there are not enough non-high priority credits, the downstream circuit 114 waits to communicate the non-high priority information until the upstream receiver 130 gives the downstream transmitter 124 enough credits to communicate the information. The process ends in step 210.

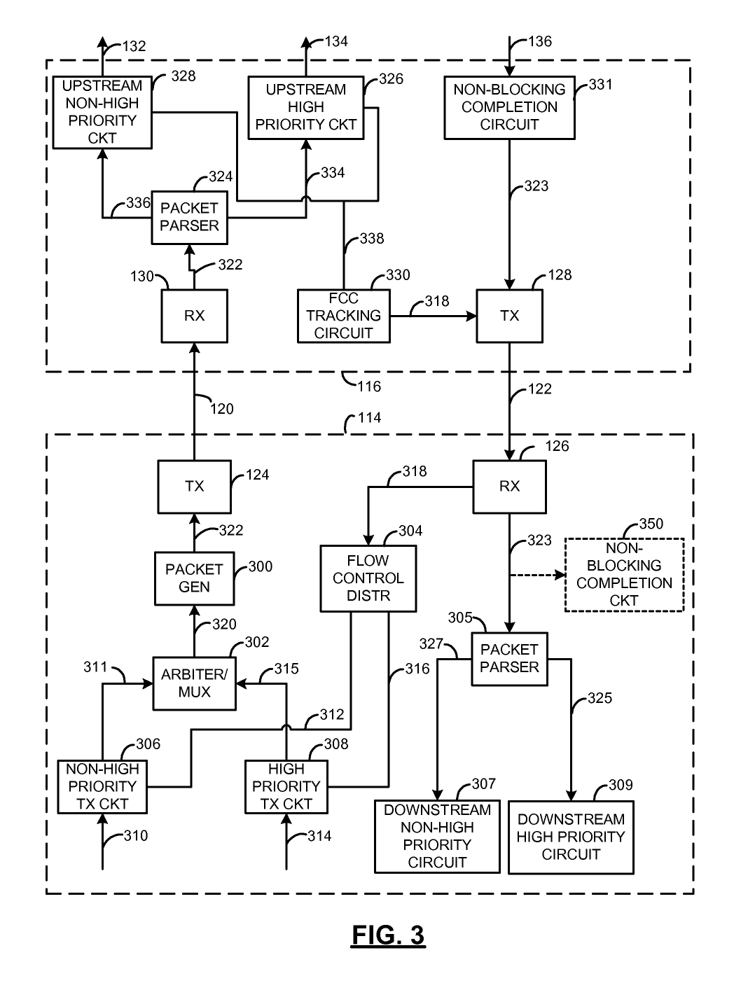

Referring now to FIG. 3, a functional block diagram of one example of the downstream circuit 114 and the upstream circuit 116 is depicted. The downstream circuit 114 includes the downstream transmitter 124, the downstream receiver 126, a packet generator 300, an arbiter 302, a flow control distributor 304, a downstream packet parser 305, a non-high priority control circuit 306, a downstream non-high priority circuit 307, a high priority control circuit 308, and a downstream high priority circuit 309. The packet generator 300 is operatively coupled to the downstream transmitter 124 and the arbiter 302. The arbiter 302 is operatively coupled to the non-high priority control circuit 306 and the high priority control circuit 308. The non-high priority control circuit 306 and the high priority control circuit 308 are operatively coupled to the flow control distributor 304, which is operatively coupled to the downstream receiver 126. The downstream packet parser 305 is operatively coupled to the downstream receiver 126, the downstream non-high priority circuit 307, and the downstream high priority circuit 309.

The non-high priority control circuit 306 receives non-high priority information 310 and selectively communicates non-high priority information 311, which is based on the non-high priority information 310, to the arbiter 302. More specifically, the non-high priority control circuit 306 communicates the non-high priority information 311 to the arbiter 302 when non-high priority flow control information 312 indicates that there are enough non-high priority credits available to communicate the non-high priority information 311. When the non-high priority flow control information 312 indicates that there are not enough non-high priority credits available to communicate the non-high priority information 311, the non-high priority circuit 306 buffers and/or stalls the non-high priority information 310 until enough credits become available.

Similarly, the high priority control circuit 308 receives high priority information 314 and selectively communicates high priority information 315, which is based on the high priority information 314, to the arbiter 302. More specifically, the high priority control circuit 308 communicates the high priority information 315 to the arbiter 302 when high priority flow control information 316 indicates that there are enough high priority credits available to communicate the high priority information 315. When the high priority flow control information 316 indicates that there are not enough high priority credits available to communicate the high priority information 315, the high priority circuit 310 buffers and/or stalls the high priority information 314 until enough credits become available.

The flow control distributor 304 receives a total number of flow control credits 318 from the downstream receiver 126 and distributes the credits into high priority credits and non-high priority credits. The flow control distributor 304 is also operative to control communication of the non-high priority information 310, 311 by the non-high priority control circuit 306 based on the non-high priority flow control information 312. Furthermore, the flow control distributor 304 controls communication of the high priority information 314, 315 by the high priority control circuit 308 based on the high priority flow control information 316.

In addition, the flow control distributor 304 is also operative to track consumption of the high priority credits when the high priority control circuit 308 communicates the high priority information 314, 315. For example, if the high priority control circuit 308 communicates high priority information that includes a memory read request, one request (or header) credit may be subtracted from the high priority credits. In a similar manner, the flow control distributor 304 tracks consumption of the non-high priority credits when the non-high priority control circuit 306 communicates the non-high priority information 310, 311.

Furthermore, the flow control distributor 304 adds new high priority flow control credits to the remaining high priority credits and adds new non-high priority credits to the remaining non-high priority credits based on the total number of flow control credits 318. In some embodiments, the flow control distributor 304 may add a predetermined amount of credits to the high priority credits and then add any additional credits to the non-high priority credits. For example, if the total flow control credits information 318 indicates that there are 30 new credits available, the flow control distributor 304 can add 20 credits to the high priority credits and the remaining 10 credits to the non-high priority credits. In other embodiments, the flow control distributor 304 may add a first percentage of credits to the high priority credits and a second percentage of credits to the non-high priority credits. For example, if the total flow control credit information 318 indicates that there are 50 new credits available, the flow control distributor 304 can add 20% of the new credits (e.g., 10 credits) to the high priority credits and 80% of the new credits (e.g., 40 credits) to the non-high priority credits.

The arbiter 302 receives the non-high priority information 311 and the high priority information 315. The arbiter 302 communicates the high priority information 315 prior to the non-high priority information 311. In some embodiments, the arbiter 302 may also multiplex the non-high priority information 311 and high priority information 315 into a combined information 320 that includes both the non-high priority information 311 and high priority information 315.

The packet generator 300 receives the combined information 320 and to generate one or more packets 322 based on the combined information 320. When the packet generator 300 generates a packet that includes high priority information 315, the packet generator 300 sets a traffic class identifier in the header of the packet to indicate that the payload of the packet includes high priority information 315. In a similar manner, the packet generator 300 sets the traffic class in the header to indicate that the payload includes non-high priority information 311 when the packet generator 300 generates a packet that includes non-high priority information 311. The downstream transmitter 124 receives the packet 322 and transmits the packet 322 along the upstream path 120 of the differential serial communication link 118.

In some embodiments, one or more packets 323 received from the downstream receiver 126 are communicated to a downstream non-blocking completion circuit 350. In other embodiments, the downstream packet parser 305 parses the packets 323 received from the downstream receiver 126 into high priority information 325 and non-high priority information 327 based on the traffic class in the header of the packet 323. For example, the downstream packet parser 305 may parse the packet 323 into high priority information 325 when the traffic class is set to a first value such as 1 and into non-high priority information 327 when the traffic class is set to a second value such as 0. The high priority information 325 is communicated to the downstream high priority circuit 309. The non-high priority information 327 is communicated to the downstream non-high priority circuit 307.

The upstream circuit 116 includes the upstream transmitter 128, the upstream receiver 130, an upstream packet parser 324, an upstream high priority circuit 326, an upstream non-high priority circuit 328, a flow control credit tracking circuit 330, and a completion circuit 331. The upstream receiver 130 is operatively coupled to the upstream packet parser 324 and the flow control credit tracking circuit 330. The upstream packet parser 324 is operatively coupled to the upstream receiver 130, the high priority circuit 326, and the non-high priority circuit 328. The flow control credit tracking circuit 330 is operatively coupled to the upstream receiver 130 and the upstream transmitter 128. The non-blocking completion circuit 331 is operatively coupled to the upstream transmitter 128.

The upstream receiver 130 receives one or more packets 322 from the upstream path 120 of the differential serial communication link 118. The receiver 130 communicates the packet 322 to the upstream packet parser 324. The upstream packet parser 324 parses the packet 322 into high priority information 334 and non-high priority information 336 based on the traffic class in the header of the packet 322. For example, the upstream packet parser 324 may parse the packet 322 into high priority information 334 when the traffic class is set to a first value such as 1 and into non-high priority information 336 when the traffic class is set to a second value such as 0.

The high priority circuit 326 receives the high priority information 334 and to communicate it to the high priority interface 134. The non-high priority circuit 328 receives the non-high priority information 336 and communicates it to the non-high priority interface 132. As previously discussed, the high priority interface 134 provides a non-blocking path to system memory 108, which ensures that the high priority information 334 is preferentially communicated to system memory 108 over the non-high priority information 336.

The flow control tracking circuit 330 tracks how much information the receiver 130 is capable of receiving. More specifically, the flow control tracking circuit 330 monitors capacity information 338 of the upstream high priority circuit 326 and the upstream non-high priority circuit 328. The flow control tracking circuit 330 generates the total number of flow control credits information 318 based on the capacity information 338. The upstream transmitter 128 receives the total flow control credits information 318 and communicates the total flow control credits information 318 to the downstream path 122 of the differential serial communication link 118.

The completion circuit 331 receives information based on the high and non-high priority requests from the system memory 108 via the non-blocking completion path 136. The completion circuit 331 generates the packet 323 based on the information received via the non-blocking completion path 136. When the completion circuit 331 generates the packet 323, the completion circuit 331 sets a traffic class in the header of the packet 323 to indicate that the payload includes high priority information 325. The downstream transmitter 124 receives the packet 323 and transmits the packet 323 along the downstream path 122 of the differential serial communication link 118.

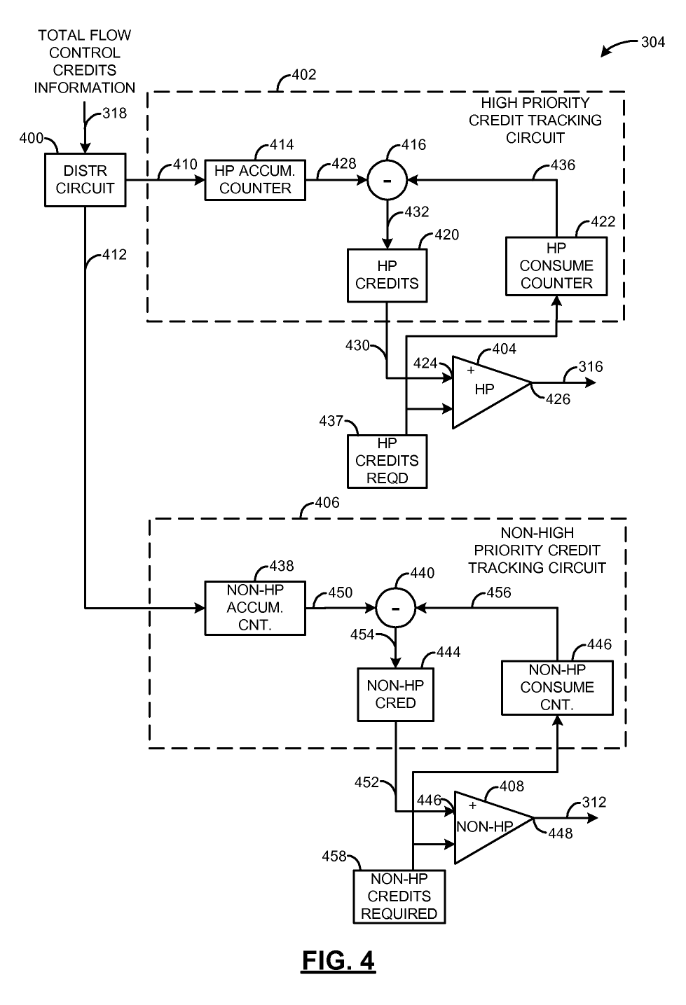

Referring now to FIG. 4, an exemplary functional block diagram of the flow control distributor 304 is depicted. The flow control distributor 304 includes a distributor circuit 400, a high priority credit tracking circuit 402, a high priority comparator 404, a non-high priority credit tracking circuit 406, and a non-high priority comparator 408. The high priority credit tracking circuit 402 is operatively coupled to the distributor circuit 400 and the high priority comparator 404. The non-high priority credit tracking circuit 406 is operatively coupled to the distributor circuit 400 and the non-high priority comparator 408.

The distributor circuit 400 receives the total flow control credits information 318 and distributes the total flow control credits information 318 into high priority credits 410 and non-high priority credits 412. As previously discussed, in some embodiments, the flow control distributor 304 may add a predetermined amount of credits to the high priority credits and then add any remaining credits to the non-high priority credits. In other embodiments, the flow control distributor 304 may add a first percentage of credits to the high priority credits and a second percentage of credits to the non-high priority credits.

The high priority credit tracking circuit 402 includes a high priority accumulation counter 414, a high priority subtracter 416, a high priority credit register 420, and a high priority consume counter 422. The high priority subtracter 416 is operatively coupled to the high priority accumulation counter 414, the high priority consume counter 422, and the high priority credit register 420. The high priority credit register 420 is operatively coupled to a first input 424 of the high priority comparator 404. The high priority consume counter 422 is operatively coupled to the subtracter 416 and high priority credits required 437.

The high priority accumulation counter 414 generates high priority accumulation information 428 based on the high priority credits 410. More specifically, the high priority accumulation counter 414 increments for each high priority credit 410 received from the distribution circuit 400 and generates the high priority accumulation information 428 based thereon. Alternate embodiments can deliver the credits directly. Although the high priority accumulation counter 414 increments in this example, skilled artisans will recognize that the high priority accumulation counter 414 may decrement in some embodiments and that other suitable structures may be used to provide the described functionality.

The high priority credit register 420 stores and provides current high priority credit information 430 to the first input 424. The high priority subtracter 416 generates high credits available information 432 based on the high priority accumulation information 428 and high priority consume information 436. The high priority credits available information 432 indicates how many credits to store in the high priority credit register 420.

The high priority consume counter 422 increments based on the high priority flow control information 316 and high priority credits required information 437. More specifically, the high priority consume counter 422 increments for each current high priority credits required information 437 used to communicate high priority information to the upstream path 120 of the differential serial communication link 118 and generates the high priority consume information 436 based thereon. Although the high priority consume counter 422 increments in this example, skilled artisans will recognize that the high priority consume counter 422 may decrement in some embodiments and that other suitable structures may be used to provide the described functionality.

The high priority comparator 404 receives the current high priority credits 430 and high priority credits required information 437, which indicates how many credits are required to communicate high priority information to the upstream path 120. The high priority comparator 404 generates the high priority flow control information 316 based on the current high priority credits 430 and high priority credits required information 437. More specifically, the high priority comparator 404 generates the flow control information 316 when the high priority credits required information 437 is less than or equal to the current high priority credits 430.

The non-high priority credit tracking circuit 406 includes a non-high priority accumulation counter 438, a non-high priority subtracter 440, a non-high priority credit register 444, and a non-high priority consume counter 446. The non-high priority subtracter 440 is operatively coupled to the non-high priority accumulation counter 438, the non-high priority consume counter 446, and the non-high priority credit register 444. The non-high priority credit register 444 is operatively coupled to a first input 446 of the non-high priority comparator 408. The non-high priority consume counter 446 is operatively coupled to the non-high priority subtracter 440 and non-high priority credits required information 458.

The non-high priority accumulation counter 438 generates non-high priority accumulation information 450 based on the non-high priority credits 412. More specifically, the non-high priority accumulation counter 438 increments for each non-high priority credit 412 received from the distribution circuit 400 and generates the non-high priority accumulation information 450 based thereon. Although the non-high priority accumulation counter 438 increments in this example, skilled artisans will recognize that the non-high priority accumulation counter 438 may decrement in some embodiments and that other suitable structures may be used to provide the described functionality.

The non-high priority credit register 444 stores and provides current non-high priority credit information 452 to the first input 446. The non-high priority subtracter 440 generates non-high priority credits available information 454 based on the non-high priority accumulation information 450 and non-high priority consume information 456. The non-high priority credits available information 454 indicates how many credits to store in the non-high priority credit register 444.

The non-high priority consume counter 446 increments based on the non-high priority flow control information 312 and non-high priority credits required information 458. More specifically, the non-high priority consume counter 446 increments for each current non-high priority credit required information 458 used to communicate non-high priority information to the upstream path 120 of the differential serial communication link 118 and generates the non-high priority consume information 456 based thereon. Although the non-high priority consume counter 446 increments in this example, skilled artisans will recognize that the non-high priority consume counter 446 may decrement in some embodiments and that other suitable structures may be used to provide the described functionality.

The non-high priority comparator 408 receives the current non-high priority credits 452 and non-high priority credits required information 458, which indicates how many credits are required to communicate non-high priority information to the upstream path 120. The non-high priority comparator 408 generates the non-high priority flow control information 312 based on the current non-high priority credits 452 and non-high priority credits required information 458. More specifically, the non-high priority comparator 408 generates the non-high priority flow control information 312 when the non-high priority credits required information 458 is less than or equal to the current non-high priority credits 452.

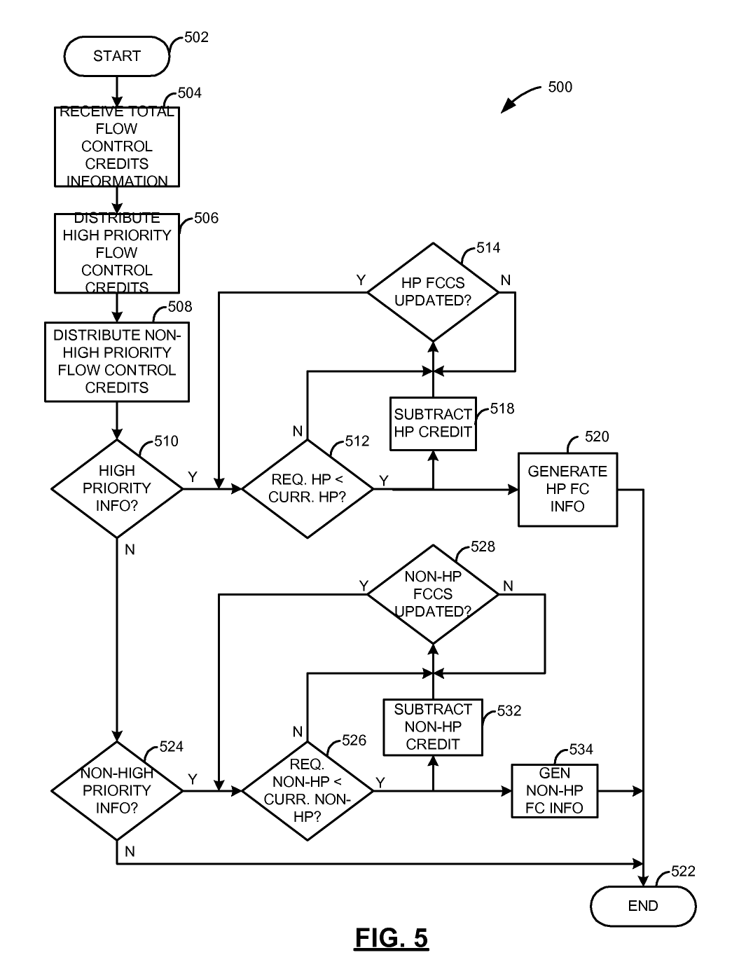

Referring now to FIG. 5, exemplary steps that may be taken by the flow control distributor 304 are generally identified at 500. The process starts in step 502 when the differential serial communication link 118 between the downstream circuit 114 and upstream circuit 116 is initialized. In step 504, the distributor circuit 400 receives the total flow control information 318 from the upstream receiver 130. In step 506, the distributor circuit 400 distributes the total number of credits information 318 into the high priority credits 410. In step 508, the distributor circuit 400 distributes the total number of credits information 318 into the non-high priority credits 412.

In step 510, the flow control distributor 306 determines whether high priority information 314 is to be communicated to the upstream path 120 of the differential communication link 118. If high priority information 314 is to be communicated, the high priority comparator 404 determines whether the required high priority credits 437 are less than or equal to the current high priority credits 430 in step 512. If the required high priority credits 437 are not less than or equal to the current high priority credits 430, the flow control distributor 304 determines whether the high priority credits have been updated in step 514. If the high priority credits have been updated, the process returns to step 512.

If the high priority comparator 404 determines that the required high priority credits 437 are less than the current high priority credits 430 in step 512, the high priority subtracter 418 subtracts credits based on the high priority flow control information 316 in step 518. In addition, if the required high priority credits 437 are less than or equal to the current high priority credits 430, the high priority comparator 404 generates the high priority flow control information 316 in step 520 and the process ends in step 522.

If the flow control distributor 306 determines that high priority information 314 is not to be communicated in step 510, flow control distributor determines whether non-high priority information 310 is to be communicated in step 524. If non-high priority information 310 is to be communicated, the non-high priority comparator 408 determines whether the required non-high priority credits 452 are less than or equal to the current non-high priority credits 458 in step 526. If the required non-high priority credits 452 are not less than or equal to the current non-high priority credits 458, the flow control distributor 304 determines whether the non-high priority credits have been updated in step 528. If the non-high priority credits have been updated, the process returns to step 526.

If the non-high priority comparator 408 determines that the required non-high priority credits 458 are less than or equal to the current non-high priority credits 452 in step 526, the non-high priority subtracter 442 subtracts credits based on the non-high priority flow control information 312 in step 532. In addition, if the required non-high priority credits 458 are less than the current non-high priority credits 452, the non-high priority comparator 408 generates the non-high priority flow control information 312 in step 534 and the process ends in step 522.

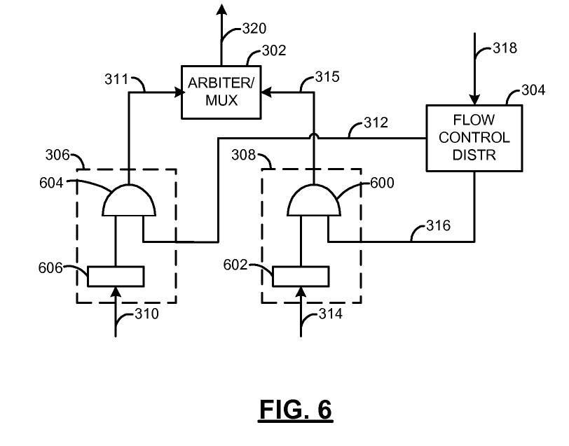

Referring now to FIG. 6, a functional block diagram of an exemplary implementation of the high priority control circuit 308 and the non-high priority control circuit 306 is depicted. The high priority control circuit 308 includes a high priority AND gate 600 and a high priority buffer 602. The high priority buffer 602 receives the high priority information 315 and stores the high priority information 314 until the high priority AND gate 600 is activated via the high priority flow control information 316. In this manner, the high priority information 314 is communicated by the high priority control circuit 308 when the high priority flow control information 316 indicates that enough high priority flow control credits are available to communicate the high priority information 314, 315.

The non-high priority control circuit 306 includes a non-high priority AND gate 604 and a non-high priority buffer 606. The non-high priority buffer 606 receives the non-high priority information 310 and stores the non-high priority information 310 until the non-high priority AND gate 604 is activated via the non-high priority flow control information 312. In this manner, the non-high priority information 311 is communicated by the non-high priority control circuit 306 when the non-high priority flow control information 312 indicates that enough non-high priority flow control credits are available to communicate the non-high priority information 310, 311.

As noted above, among other advantages, throughput of high priority information in a single differential serial communication link is increased. By using a single differential serial communication link, hardware required to support the link is minimized. Minimizing the hardware required to support the link can result in reduced power consumption and can help to decrease the overall size of the circuit and device. In addition, the method and apparatus provides multi-priority communication in applications that do not allow multiple differential serial communication links. Other advantages will be recognized by those of ordinary skill in the art.

While this disclosure includes particular examples, it is to be understood that the disclosure is not so limited. Numerous modifications, changes, variations, substitutions, and equivalents will occur to those skilled in the art without departing from the spirit and scope of the present disclosure upon a study of the drawings, the specification, and the following claims.

What is claimed is:

1. A circuit, comprising:
a high priority circuit that is operative to communicate high priority information to a single path of a differential serial communication link; and
a non-high priority circuit that is operative to communicate non-high priority information to the single path, wherein the high priority information is communicated prior to the non-high priority information.

2. The circuit of claim 1 further comprising an arbiter operatively coupled to the high priority circuit and the non-high priority circuit that is operative to receive the high priority information and the non-high priority information and to communicate the high priority information to the single path prior to the non-high priority information.

3. The circuit of claim 1 further comprising a packet generator that is operative to generate a packet based on one of the high priority information and the non-high priority information, wherein packet includes a header that indicates whether the packet includes the one of high priority information and non-high priority information.

4. The circuit of claim 1 further comprising a flow control distributor operatively coupled to the high priority circuit and the non-high priority circuit that is operative to distribute a total number of flow control credits into high priority credits and non-high priority credits and to control communication of the high priority information based on the high priority credits and communication of the non-high priority information based on the non-high priority credits.

5. The circuit of claim 4 wherein the high priority circuit is operative to communicate high priority information based on the high priority credits and wherein the non-high priority circuit is operative to communicate non-high priority information based on the non-high priority credits.

6. The circuit of claim 4 wherein the flow control distributor is operative to subtract at least one credit from the high priority credits when the high priority circuit communicates the high priority information and to subtract at least one credit from the non-high priority credits when the non-high priority circuit communicates the high priority information.

7. The circuit of claim 6 further comprising a receiver that is operative to receive information including the total number of flow control credits from a downstream path of the differential serial communication link.

8. The circuit of claim 7 wherein the receiver is operative to communicate a payload of the information received to a non-blocking completion circuit.

9. The circuit of claim 7 wherein the flow control distributor is operative to add a first percentage of credits to the high priority credits and a second percentage of credits to the non-high priority credits based on the total number of flow control credits.

10. The circuit of claim 7 wherein the flow control distributor is operative to add at least one credit to the high priority credits based on the total number of flow control credits when the high priority credits are less than a predetermined value and to add at least one credit to the non-high priority credits based on the total number of flow control credits when the high priority credits are one of greater than and equal to the predetermined value.

11. The circuit of claim 4 wherein the flow control distributor comprises:
a distributor that is operative to distribute the total number of flow control credits into the high priority credits and the non-high priority credits;
a high priority tracking circuit that is operative to add at least one credit to the high priority credits based on total number of flow control credits and to subtract at least one credit from the high priority credits when the high priority information is communicated; and
a non-high priority tracking circuit that is operative to add at least one credit to the non-high priority credits based on the total number of flow control credits and to subtract at least one credit from the non-high priority credits when the non-high priority information is communicated.

12. The circuit of claim 11 wherein the high priority tracking circuit comprises:
a high priority accumulation counter that is operative to count credits distributed to the high priority credits;
a high priority consumption counter operatively coupled to the high priority circuit that is operative to count credits consumed when the high priority information is communicated; and
a high priority subtraction circuit operatively coupled to the high priority consumption counter that is operative to subtract the at least one credit from the high priority credits based on the credits consumed.

13. The circuit of claim 11 wherein the non-high priority tracking circuit comprises:
a non-high priority accumulation counter that is operative to count credits distributed to the non-high priority credits;
a non-high priority consumption counter operatively coupled to the non-high priority circuit that is operative to count credits consumed when the non-high priority information is communicated; and
a non-high priority subtraction circuit operatively coupled to the non-high priority consumption counter that is operative to subtract the at least one credit from the non-high priority credits based on the credits consumed.

14. The circuit of claim 11 wherein the flow control distributor comprises:
a high priority comparator that is operative to enable the high priority circuit to communicate the high priority information when a number of credits required to communicate the high priority information is one of less than and equal to the high priority credits; and
a non-high priority comparator that is operative to enable the non-high priority circuit to communicate the non-high priority information when a number of credits required to communicate the non-high priority information is one of less than and equal to the non-high priority credits.

15. A circuit, comprising:
a packet parser that is operative to receive a packet from a single path of a differential serial communication link and that is operative to classify the packet into one of high priority information and non-high priority information;
a high priority circuit that is operative to communicate the high priority information to a non-blocking high priority interface; and
a non-high priority circuit that is operative to communicate the non-high priority information to a non-high priority interface.

16. The circuit of claim 15 wherein the single path is one of a single downstream path and a single upstream path.

17. The circuit of claim 15 wherein the non-blocking high priority interface is operatively coupled to system memory.

18. The circuit of claim 15 further comprising a transceiver that includes transmitter and a receiver, wherein the transmitter is operative to transmit flow control credit information based on a capacity of the receiver to receive packets.

19. A method of controlling priority of information of a single path of a differential serial communication link, comprising:
distributing a total number of flow control credits into high priority credits and non-high priority credits;
selectively communicating high priority information to the single path of the differential serial communication link based on the high priority credits; and
selectively communicating non-high priority information to the single path of the differential serial communication link based on the non-high priority credits, wherein the high priority information is communicated prior to the non-high priority information.

20. The method of claim 19 further comprising:
communicating the high priority information when a number of credits required to communicate the high priority information is one of less than and equal to the high priority credits; and
communicating the non-high priority information when a number of credits required to communicate the non-high priority information is one of less than and equal to the non-high priority credits.

21. A device, comprising:
at least one processor;
memory;
a multi-priority communication system, operatively coupled to the at least one processor and memory, that comprises:
an upstream integrated circuit that comprises:
a packet parser that is operative to receive a packet from a single upstream path of a differential serial communication link and that is operative to classify the packet into one of high priority information and non-high priority information,
an upstream high priority circuit that is operative to communicate the high priority information to a non-blocking high priority interface operatively coupled to memory, and
an upstream non-high priority circuit that is operative to communicate the non-high priority information to a non-high priority interface;
a downstream integrated circuit that comprises:
a downstream high priority circuit that is operative to communicate the high priority information to the single upstream path,
a downstream non-high priority circuit that is operative communicate non-high priority information to the single upstream path, wherein the high priority information is communicated prior to the non-high priority information, and
a flow control distributor operatively coupled to the downstream high priority circuit and the downstream non-high priority circuit that is operative to distribute a total number of flow control credits into high priority credits and non-high priority credits and to control communication of the high priority information based on the high priority credits and communication of the non-high priority information based on the non-high priority credits; and
a display operatively coupled to the multi-priority communication system that is operative to generate display information based on the high priority information.

22. A circuit, comprising:
a high priority circuit that is operative to communicate high priority information to a single path; and
a non-high priority circuit that is operative to communicate non-high priority information to the single upstream path, wherein the high priority information is communicated prior to the non-high priority information.
